(19) United States
(12) Patent Application Publication
(10) Pub. No.: US 2024/0369444 A1
(43) Pub. Date: Nov. 7, 2024

(54) VIBRATION TABLE BASED ON FLUID COOLING

(71) Applicant: SUZHOU SUSHI TESTING GROUP CO., LTD., Suzhou, Jiangsu (CN)

(72) Inventor: Jin ZHOU, Suzhou (CN)

(73) Assignee: SUZHOU SUSHI TESTING GROUP CO., LTD., Suzhou, Jiangsu (CN)

(21) Appl. No.: 18/688,816

(22) PCT Filed: May 31, 2022
(86) PCT No.: PCT/CN2022/096272

§ 371 Date: Mar. 4, 2024

(30) Foreign Application Priority Data
Sep. 8, 2021 (CN) 202111049871.9

(51) Int. Cl. G01M 7/02

(52) U.S. Cl. CPC G01M 7/02

(57) ABSTRACT

The present invention discloses a vibration table based on fluid cooling, including: a pressure bearing table body and a fluid supply device, wherein the pressure bearing table body includes a cavity and a moving ring located in the cavity, a through hole is formed in an upper housing of the cavity, and the moving ring penetrates out of the through hole; the cavity is provided therein with a driving device and a cooling system, the driving device can drive the moving ring to vibrate up and down, and the cooling system is configured to refrigerate the cavity; the fluid supply device receives fluid from the cavity, refrigerates the fluid, and outputs the refrigerated fluid to the cavity. A rolling seal can isolate the cavity from an external space, so as to protect the cavity and components therein.

### TECHNICAL FIELD

The present invention relates to the field of vibration technologies, and in particular, to a vibration table based on fluid cooling.

### BACKGROUND

In practice, some apparatuses usually do not work under a normal temperature and pressure (for example, a temperature, a humidity, a dust concentration, or the like, are different from a temperature, a humidity, a dust concentration, or the like, in a normal environment), and during working, the apparatuses may generate vibration which affects reliability and service lives of the apparatuses, and therefore, during design and production, the apparatuses and related components thereof are required to be subjected to a vibration test in the corresponding working environment.

A vibration table serves as a common apparatus for generating vibration, the vibration table has a common structure of a pressure bearing table body including a cavity and a moving ring, the moving ring is provided in the cavity, a through hole is formed in an upper housing of the cavity, a top end portion of the moving ring penetrates out of the through hole, and in use, the to-be-tested apparatus is fixed to the top end portion of the moving ring: it may be appreciated that a surrounding environment may affect components in the cavity, thereby greatly reducing a service life, or the like, of the vibration table.

### SUMMARY

In view of this, a main object of the present invention is to provide a vibration table based on fluid cooling.

In order to achieve the above object, the technical solution of the present invention is realized as follows: a vibration table based on fluid cooling, comprising: a pressure bearing table body and a fluid supply device, wherein a cavity and a moving ring are comprised, the moving ring is provided in the cavity, a first through hole is formed in an upper housing of the cavity, and a top end portion of the moving ring penetrates out of the first through hole: a rolling seal for isolating the cavity from an external space is fitted and mounted in a gap between the top end portion of the moving ring and the first through hole; the cavity is provided therein with a driving device and a cooling system, the driving device can drive the moving ring to vibrate up and down, and the cooling system is configured to refrigerate the cavity: a fluid inlet and a fluid outlet are formed in a side wall of the pressure bearing table body, and the fluid inlet and the fluid outlet are communicated with the cooling system respectively; and the fluid supply device receives fluid from the fluid outlet, refrigerates the fluid, and outputs the refrigerated fluid to the fluid inlet.

As an improvement of an embodiment of the present invention, the rolling seal is configured as a seal membrane with a U-shaped cross section, and an opening of the rolling seal faces downwards.

As an improvement of an embodiment of the present invention, a first assembly groove fitted and fixedly connected with a first end of the rolling seal is formed in an upper end surface of the upper housing of the cavity, a second assembly groove fitted and fixedly connected with a second end of the rolling seal is formed in an outer side surface of the moving ring, the first assembly groove and the second assembly groove are configured as annular grooves, and the first end and the second end are configured as two opposite ends of the rolling seal.

As an improvement of an embodiment of the present invention, in the first assembly groove and the second assembly groove, a distance between two inner side surfaces gets smaller and smaller in a direction away from a bottom surface: the first assembly groove is fitted with the first end of the rolling seal, and the second assembly groove is fitted with the second end of the rolling seal.

As an improvement of an embodiment of the present invention, a ring is provided on an upper end surface of the upper housing of the cavity, a lower end surface of the ring abuts against the upper end surface of the upper housing of the cavity, and a part of the rolling seal close to the first end is sandwiched between the ring and the upper housing of the cavity.

As an improvement of an embodiment of the present invention, the ring is connected with the upper housing of the cavity by bolts.

As an improvement of an embodiment of the present invention, a groove is formed in an upper end surface of the ring, and two ends of the groove penetrate through an outer side surface and an inner side surface of the ring respectively.

As an improvement of an embodiment of the present invention, an annular groove is formed in the upper end surface of the upper housing of the cavity, and the annular groove surrounds the first through hole; and in the upper end surface of the upper housing of the cavity, a region farther from the annular groove has a larger height.

As an improvement of an embodiment of the present invention, a second through hole is formed in a bottom surface of the annular groove, and the second through hole penetrates through the upper housing of the cavity.

As an improvement of an embodiment of the present invention, a pipe joint communicated with the second through hole is provided on a lower end surface of the upper housing of the cavity.

The vibration table based on fluid cooling according to the embodiment of the present invention has the following advantages. The embodiment of the present invention discloses the vibration table based on fluid cooling, including: a pressure bearing table body and a fluid supply device, a cavity and a moving ring are included, the moving ring is provided in the cavity, a first through hole is formed in an upper housing of the cavity, and a top end portion of the moving ring penetrates out of the first through hole: a rolling seal for isolating the cavity from an external space is fitted and mounted in a gap between the top end portion of the moving ring and the first through hole: the cavity is provided therein with a driving device and a cooling system, the driving device can drive the moving ring to vibrate up and down, and the cooling system is configured to refrigerate the cavity: a fluid inlet and a fluid outlet are formed in a side wall of the pressure bearing table body, and the fluid inlet and the fluid outlet are communicated with the cooling system: the fluid supply device receives fluid from the fluid outlet, refrigerates the fluid, and outputs the refrigerated fluid to the fluid inlet. The rolling seal can isolate the cavity from the external space, so as to protect the cavity and components therein.

### BRIEF DESCRIPTION OF THE DRAWINGS

FIG. 1 is a perspective view of a vibration table according to an embodiment of the present invention;

FIG. 2 is a sectional view of the vibration table according to the embodiment of the present invention:

FIG. 3 is an enlarged view of region A in FIG. 2:

FIG. 4A is a perspective view of some assemblies in the vibration table; and

FIGS. 4B, 4C and 4D are enlarged views of regions B, C and D in FIG. 4A respectively.

### DETAILED DESCRIPTION

Hereinafter, the present invention will be described in detail in conjunction with an embodiment shown in the accompanying drawings. However, the embodiment has no limitations on the present invention, and any transformations of structure, method, or function made by persons skilled in the art according to the embodiment fall within the protection scope of the present invention.

The following description and accompanying drawings sufficiently show specific implementations of the present invention to enable those skilled in the art to practice them. Portions and features of some implementations may be included in or substituted for portions and features of other implementations. The scope of the implementations of the present invention includes the whole range of the claims as well as all available equivalents of the claims. In the present invention, the terms “first”, “second”, or the like, are used solely to distinguish one element from another element without requiring or implying any actual relationship or order between such elements. In fact, a first element can be called a second element, and vice versa. Moreover, the terms “include”, “comprise” or any other variation thereof are intended to cover non-exclusive inclusion, such that a structure, device or apparatus including a list of elements not only includes those elements, but also includes other elements not expressly listed or inherent to the structure, device or apparatus. Without further limitation, an element defined by the phrase “including an . . . ” does not exclude the presence of other identical elements in the structure, device or apparatus including the element. The various embodiments are described progressively in the present invention, each embodiment focuses on differences from the other embodiments, and for like parts among the embodiments, reference may be made to each other.

Directions or positional relationships indicated by terms “longitudinal”, “transverse”, “upper”, “lower”, “front”, “rear”, “left”, “right”, “vertical”, “horizontal”, “top”, “bottom”, “inner”, “outer”, or the like, in the present invention are based on orientations or positional relationships shown in the accompanying drawings, and they are used only for describing the present invention and for description simplicity, but do not indicate or imply that an indicated device or element must have a specific orientation or be constructed and operated in a specific orientation. Therefore, it cannot be understood as a limitation on the present invention. In the description of the present invention, unless specified and limited otherwise, the terms “mounted”, “connected” and “coupled” are used broadly, and may be, for example, mechanical or electrical connections: may also be communication of two elements: may be direct connections or indirect connections via intervening structures. To those skilled in the art, the specific meaning of the above terms may be understood in the specific circumstances.

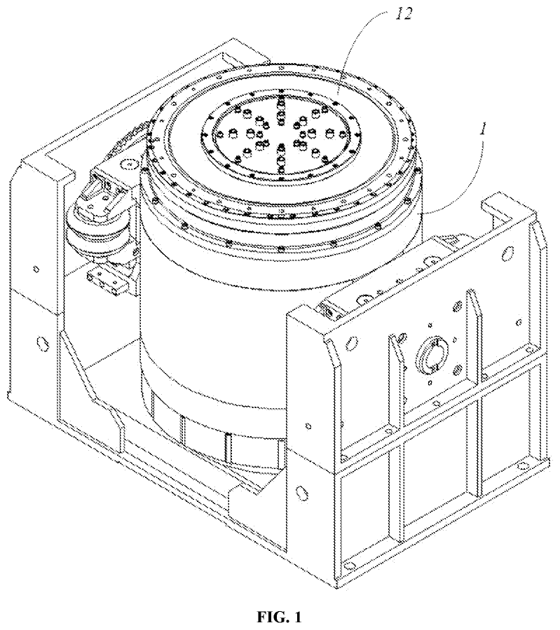

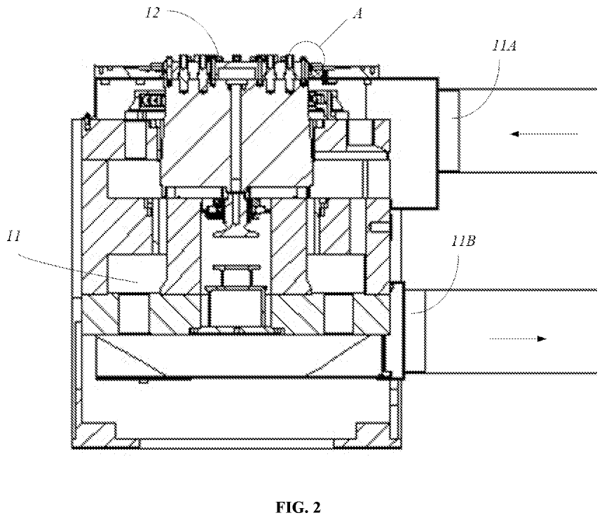

An embodiment of the present invention provides a vibration table based on fluid cooling, as shown in FIGS. 1, 2, 3, 4A, 4B, 4C and 4D, including:

a pressure bearing table body 1 and a fluid supply device, wherein a cavity 11 and a moving ring 12 are included, the moving ring 12 is provided in the cavity 11, a first through hole 111 is formed in an upper housing of the cavity 11, and a top end portion of the moving ring 12 penetrates out of the first through hole 111: a rolling seal 13 for isolating the cavity 11 from an external space is fitted and mounted in a gap between the top end portion of the moving ring 12 and the first through hole 111.

Here, in use, a to-be-tested apparatus (for example, an aerospace apparatus and related components thereof, or the like) may be fixed to the top end portion of the moving ring 12, the vibration table and the to-be-tested apparatus are placed in a corresponding environment (the aerospace apparatus usually works in a low pressure or vacuum environment), and a vibration test may be initiated: during the test, the moving ring 12 can drive the to-be-tested apparatus to move up and down, and it can be understood that vibration of the pressure bearing table body 1 is quite small due to presence of the rolling seal 13, such that the vibration table can be effectively prevented from being damaged.

The cavity 11 is provided therein with a driving device and a cooling system, the driving device can drive the moving ring 12 to vibrate up and down, and the cooling system is configured to refrigerate the cavity 11: a fluid inlet 11A and a fluid outlet 11B are formed in a side wall of the pressure bearing table body 1, and the fluid inlet 11A and the fluid outlet 11B are communicated with the cooling system respectively: the fluid supply device receives fluid from the fluid outlet 11B, refrigerates the fluid, and outputs the refrigerated fluid to the fluid inlet 11A.

Here, electromagnetic or mechanical driving may be adopted in the driving device, and during working, the driving device may generate heat, and at this point, fluid with a relatively low temperature may be input to the fluid inlet 11A, and when flowing through a refrigeration device, the fluid with a relatively low temperature absorbs heat (for example, the heat generated by the driving device) in the cavity 11 to become fluid with a relatively high temperature, and then flows out from the fluid outlet 11B, so as to cool the driving device: or, when a temperature of the measurement environment is excessively low; the temperature of the fluid flowing in from the fluid inlet 11A may be adjusted, so as to keep the temperature in the cavity 11 constant.

In summary, during an experiment, the vibration table and the to-be-tested apparatus are required to be placed in the corresponding environment which may have a high humidity, more dust and a high or low air pressure, but the rolling seal 13 can isolate the cavity 11 from the external space, so as to protect the cavity 11 and components therein; furthermore, the temperature in the cavity 11 can be regulated using the fluid inlet 11A and the fluid outlet 11B.

In the present embodiment, the rolling seal 13 is configured as a seal membrane with a U-shaped cross section, and an opening of the rolling seal 13 faces downwards.

In the present embodiment, a first assembly groove 112 fitted and fixedly connected with a first end of the rolling seal 13 is formed in an upper end surface of the upper housing of the cavity 11, a second assembly groove 121 fitted and fixedly connected with a second end of the rolling seal 13 is formed in an outer side surface of the moving ring 12, the first assembly groove and the second assembly groove are configured as annular grooves, and the first end and the second end are configured as two opposite ends of the rolling seal 13.

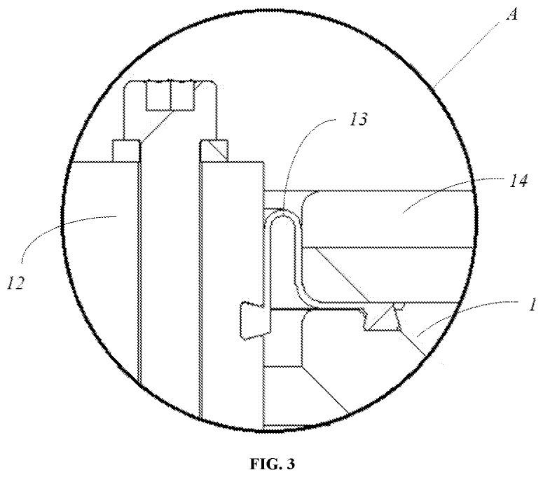

In the present embodiment, in the first assembly groove 112 and the second assembly groove 121, a distance between two inner side surfaces gets smaller and smaller in a direction away from a bottom surface: the first assembly groove 112 is fitted with the first end of the rolling seal 13, and the second assembly groove 121 is fitted with the second end of the rolling seal 13. Here, as shown in FIG. 3, cross sections of the first assembly groove 112 and the second assembly groove 121 have a shape with a large bottom and a small opening, the first assembly groove 112 and the second assembly groove 121 are fitted with the first end and the second end respectively, and the first assembly groove 112 and the second assembly groove 121 can fasten the first end and the second end, thereby effectively preventing the first end and the second end from sliding out of the first assembly groove 112 and the second assembly groove 121.

In the present embodiment, a ring 14 is provided on an upper end surface of the upper housing of the cavity 11, a lower end surface of the ring 14 abuts against the upper end surface of the upper housing of the cavity 11, and a part of the rolling seal 13 close to the first end is sandwiched between the ring 14 and the upper housing of the cavity 11. Here, the ring 14 can effectively fix the part of the rolling seal 13 close to the first end to the upper end surface of the upper housing of the cavity 11.

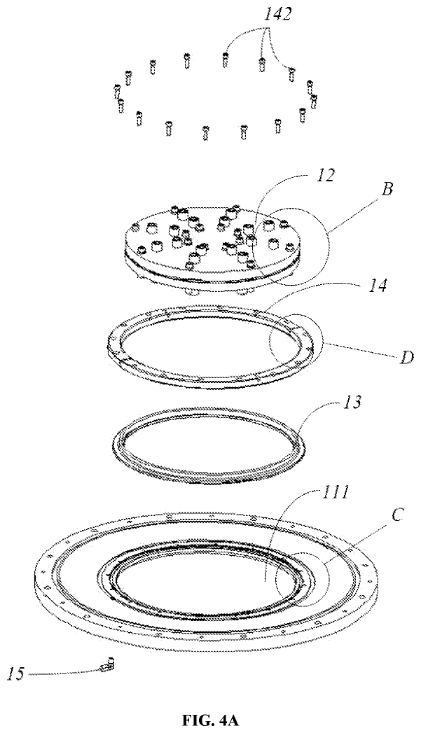

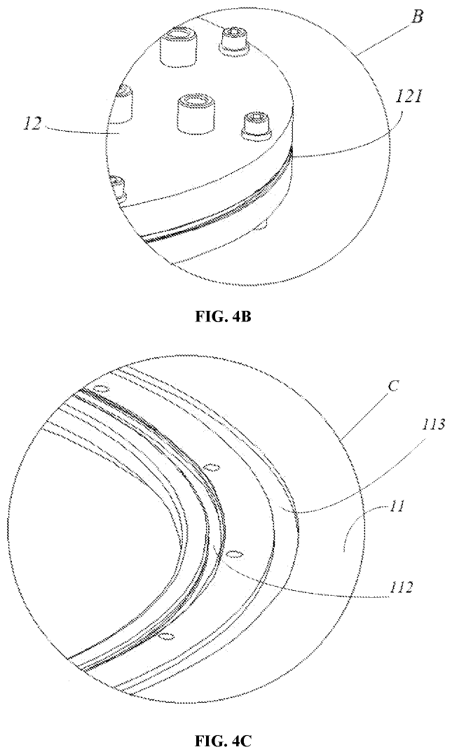

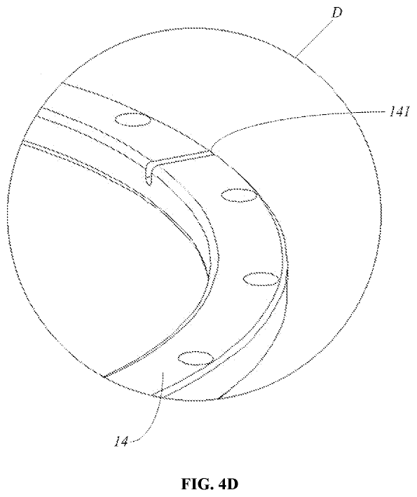

In the present embodiment, the ring 14 is connected with the upper housing of the cavity 11 by bolts 142. Here, as shown in FIG. 4A, a plurality of through holes are formed in the ring 14, a plurality of screw holes are correspondingly formed in the upper housing of the cavity 11, and then, the bolts 142 are inserted through the through holes from top to bottom, then screwed into the corresponding screw holes and tightened.

In the present embodiment, a groove 141 is formed in an upper end surface of the ring 14, and two ends of the groove 141 penetrate through an outer side surface and an inner side surface of the ring 14 respectively. In use, the to-be-tested apparatus is secured to an upper surface of the moving ring 12, and it can be understood that the to-be-tested apparatus may generate water drops which may flow out through the groove 141.

In the present embodiment, an annular groove 113 is formed in the upper end surface of the upper housing of the cavity 11, and the annular groove 113 surrounds the first through hole 111; and in the upper end surface of the upper housing of the cavity 11, a region farther from the annular groove 113 has a larger height. Here, the water drops on the to-be-tested apparatus may flow onto the upper housing of the cavity 11 and then into the annular groove 113, thereby facilitating drainage.

In the present embodiment, a second through hole is formed in a bottom surface of the annular groove 113, and the second through hole penetrates through the upper housing of the cavity 11. Here, water in the annular groove 113 may be discharged through the second through hole, and as shown in FIG. 4D, a pipe joint 15 may be provided at a bottom of the upper housing, and then, a pipe is communicated with the pipe joint 15, such that the water drops of the upper housing may be discharged through the pipe.

The pipe joint 15 communicated with the second through hole is provided on a lower end surface of the upper housing of the cavity 11.

It should be understood that although the present specification is described based on embodiments, not every embodiment contains only one independent technical solution. Such a narration way of the present specification is only for the sake of clarity. Those skilled in the art should take the present specification as an entirety. The technical solutions in the respective embodiments may be combined properly to form other embodiments which may be understood by those skilled in the art.

A series of the detailed descriptions set forth above is merely specific description of feasible embodiments of the present invention, and is not intended to limit the protection scope of the present invention. Equivalent embodiments or modifications made within the spirit of the present invention shall fall within the protection scope of the present invention.

What is claimed is:

1. A vibration table based on fluid cooling, comprising:
a pressure bearing table body (1) and a fluid supply device, wherein a cavity (11) and a moving ring (12) are comprised, the moving ring (12) is provided in the cavity (11), a first through hole (111) is formed in an upper housing of the cavity (11), and a top end portion of the moving ring (12) penetrates out of the first through hole (111); a rolling seal (13) for isolating the cavity (11) from an external space is fitted and mounted in a gap between the top end portion of the moving ring (12) and the first through hole (111);
the cavity (11) is provided therein with a driving device and a cooling system, the driving device can drive the moving ring (12) to vibrate up and down, and the cooling system is configured to refrigerate the cavity (11);
a fluid inlet (11A) and a fluid outlet (11B) are formed in a side wall of the pressure bearing table body (1), and the fluid inlet (11A) and the fluid outlet (11B) are communicated with the cooling system respectively; and
the fluid supply device receives fluid from the fluid outlet (11B), refrigerates the fluid, and outputs the refrigerated fluid to the fluid inlet (11A).

2. The vibration table according to claim 1,
wherein the rolling seal (13) is configured as a seal membrane with a U-shaped cross section, and an opening of the rolling seal (13) faces downwards.

3. The vibration table according to claim 2,
wherein a first assembly groove (112) fitted and fixedly connected with a first end of the rolling seal (13) is formed in an upper end surface of the upper housing of the cavity (11), a second assembly groove (121) fitted and fixedly connected with a second end of the rolling seal (13) is formed in an outer side surface of the moving ring (12), the first assembly groove and the second assembly groove are configured as annular grooves, and the first end and the second end are configured as two opposite ends of the rolling seal (13).

4. The vibration table according to claim 3,
wherein in the first assembly groove (112) and the second assembly groove (121), a distance between two inner side surfaces gets smaller and smaller in a direction away from a bottom surface;
the first assembly groove (112) is fitted with the first end of the rolling seal (13), and the second assembly groove (121) is fitted with the second end of the rolling seal (13).

5. The vibration table according to claim 4,
wherein a ring (14) is provided on an upper end surface of the upper housing of the cavity (11), a lower end surface of the ring (14) abuts against the upper end surface of the upper housing of the cavity (11), and a part of the rolling seal (13) close to the first end is sandwiched between the ring (14) and the upper housing of the cavity (11).

6. The vibration table according to claim 5,
wherein the ring (14) is connected with the upper housing of the cavity (11) by bolts (142).

7. The vibration table according to claim 5,
wherein a groove (141) is formed in an upper end surface of the ring (14), and two ends of the groove (141) penetrate through an outer side surface and an inner side surface of the ring (14) respectively.

8. The vibration table according to claim 1,
wherein an annular groove (113) is formed in the upper end surface of the upper housing of the cavity (11), and the annular groove (113) surrounds the first through hole (111); and
in the upper end surface of the upper housing of the cavity (11), a region farther from the annular groove (113) has a larger height.

9. The vibration table according to claim 8,
wherein a second through hole is formed in a bottom surface of the annular groove (113), and the second through hole penetrates through the upper housing of the cavity (11).

10. The vibration table according to claim 9,
wherein a pipe joint (15) communicated with the second through hole is provided on a lower end surface of the upper housing of the cavity (11).
